(19) United States
(12) Patent Application Publication
(10) Pub. No.: US 2009/0233002 A1
(43) Pub. Date: Sep. 17, 2009

(54) METHOD OF ANTI-GLARE SURFACE TREATMENT

(75) Inventors: Li-Chen Huang, Taipei City (TW); Huai-An Li, Taoyuan County (TW); Sheng-Fa Liu, Hsinchu County (TW); Yu-Hsien Chen, Kaohsiung City (TW); Yu-Cheng Lo, Taipei County (TW); Chung-Nan Lee, Taipei County (TW); Shu-Mei Chang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/334,513

(22) Filed: Dec. 14, 2008

(30) Foreign Application Priority Data
Mar. 14, 2008 (TW) 97109128

(51) Int. Cl. B05D 5/06

(52) U.S. Cl. 427/508; 427/162

(57) ABSTRACT

A method of an anti-glare surface treatment including following steps is provided. First, a resin layer is formed on a substrate. Next, the substrate is placed in a chamber that is filled with a water steam. A number of micro cavities are formed on a surface of the resin layer on the substrate by means of collision of the water steam. The resin layer on the substrate is then cured. The above-mentioned method of the anti-glare surface treatment is easy in process, low in cost and good in quality control.

### CROSS-REFERENCE TO RELATED APPLICATION

This application claims the priority benefit of Taiwan application serial no. 97109128, filed on Mar. 14, 2008. The entirety of the above-mentioned patent application is hereby incorporated by reference herein and made a part of this specification.

### BACKGROUND OF THE INVENTION

1. Field of the Invention

This invention is related to a method of a surface treatment, and more particularly to a method of an anti-glare surface treatment.

2. Description of Related Art

With an advancement of technologies, digital devices including mobile phones, digital cameras, digital video cameras, notebook computers, and desktop computers have made progress to meet requirements for easy operation, powerful functionality, and fantastic exterior design. Using IT products as described above demands a suitable display screen acting as a man-machine interface, and a display function of the display screen facilitates various operations. Owing to advantages of low power consumption, low radiation, and so on, a liquid crystal display (LCD) seems to have become a mainstream display apparatus. However, as the LCD displays images, external light beams may be reflected by a smooth surface of a panel of the LCD, and thus a user is prone to suffer great discomfort because of the glare.

In a conventional method of an anti-glare surface treatment, organic particles (or inorganic particles) and resin are mixed, and the mixtures are coated onto a surface of the substrate. Since the resin of the mixtures contains an easily-volatilized solvent, a thickness of the solidified resin is less than an average diameter of the organic particles (or the inorganic particles). A roughened surface can then be formed by the mixtures coated on the substrate, thereby scattering the external light beams and suppressing the glare arisen from reflection of light. Nevertheless, the organic particles are not apt to be uniformly dispersed in the resin according to said conventional method. The thickness of the cured resin can neither be precisely controlled.

### SUMMARY OF THE INVENTION

The present invention is directed to a method of an anti-glare surface treatment. The method is characterized by simple manufacturing processes, contamination resistance, and low cost barriers.

The present invention provides a method of an anti-glare surface treatment. The method includes following steps. First, a resin layer is formed on a substrate. Next, the substrate is passed through a water steam. A plurality of micro cavities are formed on the resin layer disposed on a surface of the substrate by collision of the water steam. The resin layer on the substrate is then cured.

According to an embodiment of the present invention, the method of the anti-glare surface treatment further includes disposing the substrate in the chamber that is filled with the wafer steam.

According to an embodiment of the present invention, a pressure of the wafer steam in the chamber ranges from 0.01 atm to 22 atm.

According to an embodiment of the present invention, the pressure of the wafer steam in the chamber is 1 atm.

According to an embodiment of the present invention, a process temperature in the chamber ranges from 0° C. to 374° C.

According to an embodiment of the present invention, the process temperature in the chamber ranges from 40° C. to 100° C.

According to an embodiment of the present invention, the method of forming the resin layer on the substrate includes a coating process.

According to an embodiment of the present invention, the method of forming the resin layer on the substrate includes a dip process.

According to an embodiment of the present invention, a material of the resin layer includes light curable resin.

According to an embodiment of the present invention, the method of curing the resin layer includes a light curing treatment.

According to an embodiment of the present invention, a material of the resin layer comprises thermal curable resin.

According to an embodiment of the present invention, the method of curing the resin layer includes a thermal curing treatment.

According to an embodiment of the present invention, a material of the resin layer includes polyurethane, acrylic epoxy resin, acrylic resin, epoxy resin, alkyd resin, or polyester resin.

According to an embodiment of the present invention, the substrate includes a polarizer.

According to an embodiment of the present invention, a material of the substrate includes triacetylcellulose (TAC) or polyethylene terephthalate (PET).

According to an embodiment of the present invention, the substrate includes a glass substrate.

According to an embodiment of the present invention, the plurality of micro cavities are formed on a surface of the resin layer on the substrate by means of collision of the water steam.

According to an embodiment of the present invention, the resin layer on the substrate and the wafer steam are immiscible.

In the method of the anti-glare surface treatment according to the present invention, the micro cavities are formed on the surface of the resin layer by the collision of the wafer steam, such that the external light beams are scattered. Hence, the method of the anti-glare surface treatment according to the present invention is characterized by simple manufacturing processes, contamination resistance, and low cost barriers.

In order to make the above and other objects, features and advantages of the present invention more comprehensible, an embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1C illustrate a method of an anti-glare surface treatment according to an embodiment of the present invention.

### DESCRIPTION OF EMBODIMENTS

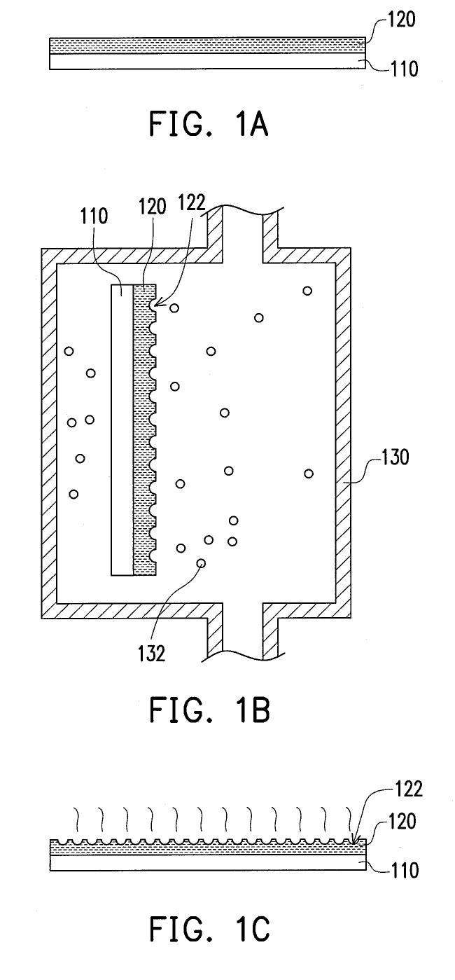

FIGS. 1A through 1C illustrate a method of an anti-glare surface treatment according to an embodiment of the present invention. Referring to FIG. 1A, a resin layer 120 is first formed on a substrate 110. In practice, the substrate 110 is, for example, a polarizer, a glass substrate, or other substrates requiring an anti-glare surface treatment. For instance, a material of the substrate 110 includes TAC or PET.

On the other hand, a material of the resin layer 120 is, for example, light curable resin. However, in other embodiments, thermal curable resin can also be chosen as the material of the resin layer 120. Specifically, the material of the resin layer 120 includes polyurethane, acrylic epoxy resin, acrylic resin, epoxy resin, alkyd resin, or polyester resin. Note that the resin layer 120 of the present embodiment need not be mixed with other particles or materials. Therefore, during the formation of the resin layer 120 of the present embodiment, a film thickness of the resin layer 120 is apt to be controlled, and thus the material of the resin layer 120 is relatively low in cost.

It should be noted that the resin layer 120 can be formed by performing a coating process or a dip process. In particular, the coating process includes implementing a spin coating process or a cast coating process for forming the resin layer 120 on the substrate 110, while the dip process includes immersing the substrate 110 into the resin material for forming the resin layer 120. It is of certainty that the method for forming the resin layer 120 on the substrate 110 is not limited to the coating process or the dip process in the present invention as long as the forming method is known to people skilled in the pertinent art.

Next, referring to FIG. 1B, the substrate 110 is placed in a chamber 130 that is filled with a water steam 132. Note that a plurality of micro cavities 122 are formed on a surface of the resin layer 120 on the substrate 110 by collision of the water steam 132. In practice, a pressure of the water steam 132 in the chamber 130 is, for example, in a range from 0.01 atm to 22 atm, preferably 1 atm. Additionally, a process temperature in the chamber 130 is, for example, in a range from 0° C. to 374° C., preferably from 40° C. to 100° C.

It should be further described that the water steam 132 and the resin layer 120 are immiscible, and thus the plurality of micro cavities 122 can be formed on the surface of the resin layer 120 when the uncured resin layer 120 collides with the water steam 132. In another aspect, the water steam is uniformly distributed in the entire chamber 130, and so are the micro cavities 122 formed on the surface of the resin layer 120 by the collision of the water steam 132. As such, the surface of the resin layer 120 in the present invention can be uniformly roughened. Note that the water steam 132 in the present embodiment can be recycled and re-used. That is to say, the method of the anti-glare surface treatment disclosed in the present invention is not only characterized by simple manufacturing processes, but also superior in contamination resistance.

Thereafter, referring to FIG. 1C, the resin layer 120 on the substrate 110 is cured. As the material of the resin layer 120 is the light curing resin, the resin layer 120 can be formed by performing a light curing treatment. In the light curing treatment, for example, an ultraviolet light is employed to irradiate the resin layer 120, so as to cure the resin layer 120. By contrast, as the material of the resin layer 120 is the thermal curable resin, the resin layer 120 can be cured by performing a thermal curing treatment. The thermal curing treatment includes heating by means of a hot plate, an IR radiation, or an oven, for example. All of the above can result in an effective curing of the resin layer 120. So far, the method of the anti-glare surface treatment in the present invention has been roughly provided. Said method of the anti-glare surface treatment according to the present invention can also be applied upon actual demands to various substrates 110 made of glass, plastic, and so on.

To sum up, the method of the anti-glare surface treatment in the present invention at least has the following advantages:

1. In the method of the anti-glare surface treatment according to the present invention, the micro cavities capable of scattering external light beams are formed by the collision of the wafer steam. Thereby, the glare arisen from the reflection of the external light can be suppressed effectively.

2. The surface of the resin layer can be uniformly roughened by performing the method of the anti-glare surface treatment according to the present invention. Besides, the film thickness of the resin layer can be managed with ease.

3. It is not required to add other particles according to the method of the anti-glare surface treatment in the present invention, and thus the manufacturing costs are relatively low.

4. The water steam used in the method of the anti-glare surface treatment according to the present invention can be recycled and re-used, and therefore said method is contamination-resistant and is conducive to protection of environment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of anti-glare surface treatment, comprising:
forming a resin layer on a substrate;
passing the substrate through a water steam, a plurality of micro cavities being formed on a surface of the resin layer on the substrate by the water steam; and
curing the resin layer on the substrate.

2. The method of the anti-glare surface treatment as claimed in claim 1, further comprising disposing the substrate into a chamber which is filled with the wafer steam.

3. The method of the anti-glare surface treatment as claimed in claim 2, wherein a pressure of the wafer steam in the chamber ranges from 0.01 atm to 22 atm.

4. The method of the anti-glare surface treatment as claimed in claim 3, wherein the pressure of the wafer steam in the chamber is 1 atm.

5. The method of the anti-glare surface treatment as claimed in claim 1, wherein a process temperature in the chamber ranges from 0° C. to 374° C.

6. The method of the anti-glare surface treatment as claimed in claim 5, wherein the process temperature in the chamber preferably ranges from 40° C. to 100° C.

7. The method of the anti-glare surface treatment as claimed in claim 1, wherein the method of forming the resin layer on the substrate comprises a coating process.

8. The method of the anti-glare surface treatment as claimed in claim 1, wherein the method of forming the resin layer on the substrate comprises a dip process.

9. The method of the anti-glare surface treatment as claimed in claim 1, wherein a material of the resin layer comprises light curable resin.

10. The method of the anti-glare surface treatment as claimed in claim 9, wherein the method of curing the resin layer comprises a light curing treatment.

11. The method of the anti-glare surface treatment as claimed in claim 1, wherein a material of the resin layer comprises thermal curable resin.

12. The method of the anti-glare surface treatment as claimed in claim 11, wherein the method of curing the resin layer comprises a thermal curing treatment.

13. The method of the anti-glare surface treatment as claimed in claim 1, wherein a material of the resin layer comprises polyurethane, acrylic epoxy resin, acrylic resin, epoxy resin, alkyd resin, or polyester resin.

14. The method of the anti-glare surface treatment as claimed in claim 1, wherein the substrate comprises a polarizer.

15. The method of the anti-glare surface treatment as claimed in claim 14, wherein a material of the substrate comprises triacetylcellulose (TAC) or polyethylene terephthalate (PET).

16. The method of the anti-glare surface treatment as claimed in claim 1, wherein the substrate comprises a glass substrate.

17. The method of the anti-glare surface treatment as claimed in claim 1, wherein the plurality of micro cavities are formed on the surface of the resin layer on the substrate by means of collision of the water steam.

18. The method of the anti-glare surface treatment as claimed in claim 1, wherein the resin layer on the substrate and the wafer steam are immiscible.
